(19) United States
(12) Patent Application Publication
(10) Pub. No.: US 2010/0072667 A1
(43) Pub. Date: Mar. 25, 2010

(54) IMPRINTING METHOD

(75) Inventors: Eigo Kawakami, Utsunomiya-shi (JP); Motoki Okinaka, Inagi-shi (JP); Hideki Ina, Tokyo (JP); Junichi Seki, Yokohama-shi (JP); Atsunori Terasaki, Kawasaki-shi (JP); Shingo Okushima, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/564,187

(22) Filed: Sep. 22, 2009

(30) Foreign Application Priority Data
Sep. 25, 2008 (JP) 2008-246335

(51) Int. Cl. B29C 39/00

(52) U.S. Cl. 264/299

(57) ABSTRACT

An imprinting method for depositing resins to a substrate, bringing a mold into contact with the resins, and transferring a pattern formed on the mold to the resins includes a first imprinting process for transferring the pattern to a first resin and a second imprinting process for forming the pattern on a second resin in an area adjacent to an area formed during the first imprinting process. The amount of the second resin to be deposited during the second imprinting process is different from that of the first resin used during the first imprinting process so that a gap between the area formed during the first imprinting process and an area to be formed during the second imprinting process is filled.

### BACKGROUND OF THE INVENTION

1. Field of the Invention

The present invention relates to imprinting methods for transferring fine patterns formed on molds to resins.

2. Description of the Related Art

Recently, fine processing techniques for easily transferring fine structures formed on molds to components to be processed such as resin films or semiconductor substrates have been developed and are attracting considerable attention (Stephan Y. Chou et al., App. Phys. Lett., Vol. 67, Issue 21, pp 3114-3116 (1995)). Such techniques are referred to as, for example, nano-imprinting or nano-embossing, and the processing dimensions correspond to the sizes of the fine structures on the molds. Transfer of structures on an order from micrometers to less than or equal to 10 nanometers has been reported. The basic principle of nano-imprinting is very simple, and is performed, for example, as follows. First, a component to be processed including a substrate (for example, a semiconductor wafer) and a resin deposited to the substrate is prepared. The resin can be, for example, a photocurable polymer, a thermoplastic polymer, or a thermosetting polymer. Next, a mold having a desired uneven pattern formed thereon is brought into contact with the component to be processed. Subsequently, the resin is cured by ultraviolet irradiation or through heating/cooling steps while the resin is filled between the substrate and the mold. Finally, the mold is detached. In this manner, the pattern is reversely transferred to the resin. These techniques enable single-step transfer of three-dimensional structures, and are expected as next-generation semiconductor manufacturing techniques to be used instead of exposure apparatuses such as steppers and scanners. Moreover, applications in a wide range of fields of, for example, optical elements such as photonic crystals, Micro Total Analysis Systems (μTAS), patterned media, and displays are also expected.

When nano-imprinting is applied to the above-described fields, large-area patterning may be required. U.S. Pat. No. 7,077,992 describes a step-and-repeat nano-imprinting process in which a pattern of a mold that is smaller than a component to be processed is repeatedly transferred. Since a small mold can be used in this process, errors accumulated during drawing a mold pattern can be suppressed, and the cost of manufacturing the mold can be reduced. Moreover, US Patent Laid-Open No. 2005-0270312 describes a drop-on-demand nano-imprinting process in which resin droplets are deposited in individual shots. In this method, the thicknesses of residual layers can be made uniform by locally adjusting amounts of resins in accordance with the density or shape of a mold pattern, and as a result, transfer accuracy can be improved. However, when drop-on-demand nano-imprinting is performed, areas without resins may be formed between two adjacent patterned resin structures. These areas without the resins are perceived as issues that may exert a large influence on the subsequent processing results.

FIGS. 7A and 7B illustrate an issue to be solved by the present invention. More specifically, FIGS. 7A and 7B illustrate a drop-on-demand nano-imprinting process in which a pattern is formed on a resin deposited to a substrate 101 using a mold 103. A transfer area to which the mold pattern is transferred during a nano-imprinting process corresponds to the area of the mold pattern. When the pattern is repeatedly transferred, boundaries appear between two adjacent transfer areas. The boundaries herein are defined as transfer boundaries 104, and the shapes thereof are, for example, square or rectangular.

When nano-imprinting is performed in the state described above, areas 701 without resins may be formed between two adjacent patterned resin structures as shown in FIG. 7A. When the substrate 101 having the areas where the substrate is exposed is etched, the substrate 101 is partly removed by etching species 702 as shown in FIG. 7B. This may degrade the uniformity of etching adjacent to the transfer areas, and moreover, may degrade the uniformity of the subsequent chemical-mechanical planarization (CMP).

### SUMMARY OF THE INVENTION

According to a first aspect of the present invention, an imprinting method for depositing resins to a substrate, bringing a mold into contact with the resins, and transferring a pattern formed on the mold to the resins includes a first imprinting process for transferring the pattern to a first resin and a second imprinting process for forming the pattern on a second resin in an area adjacent to the area formed during the first imprinting process. The amount of the second resin to be deposited during the second imprinting process is different from that of the first resin used during the first imprinting process so that a gap between the area formed during the first imprinting process and the area to be formed during the second imprinting process is filled.

According to a second aspect of the present invention, an imprinting method for depositing resin to a substrate, bringing a mold into contact with the resin, and transferring a pattern formed on the mold to the resin includes adjusting the amount of the resin to be deposited such that a gap is not formed between a patterned portion of the resin and a pre-patterned portion of the resin to be patterned during transfer of the pattern.

According to a third aspect of the present invention, an imprinting method for depositing resins to a substrate, bringing a mold into contact with the resins, and transferring a pattern formed on the mold to the resins includes bringing the mold into contact with the pre-patterned resin such that the pre-patterned resin spreads over a surface of the substrate and comes into contact with the patterned resin during transfer of the pattern to the pre-patterned resin.

Further features of the present invention will be apparent from the following description of exemplary embodiments with reference to the attached drawings.

### BRIEF DESCRIPTION OF THE DRAWINGS

FIGS. 1A and 1B illustrate an example imprinting process according to a first exemplary embodiment of the present invention.

FIGS. 2A and 2B illustrate an example imprinting process according to a second exemplary embodiment of the present invention.

FIG. 3 illustrates an example imprinting process according to a third exemplary embodiment of the present invention.

FIG. 4 illustrates an example imprinting process according to a fourth exemplary embodiment of the present invention.

FIGS. 5A and 5B illustrate example imprinting processes according to a fifth exemplary embodiment of the present invention.

FIGS. 6A and 6B illustrate an example imprinting process according to a sixth exemplary embodiment of the present invention.

FIGS. 7A and 7B illustrate an issue associated with a conventional nano-imprinting process.

### DESCRIPTION OF THE EMBODIMENTS

Resins are spread by contact with molds, and gaps between two adjacent transfer areas are filled with the spread resins such that patterns in which exposure of bases is reduced are obtained. At this moment, extension of the resins is controlled by previously formed resin structures. The amounts, densities, shapes, and ranges of the resins to be deposited in the vicinity of the structures are adjusted in accordance with the shapes and extension of the adjacent patterned resins such that the gaps between the transfer areas are filled properly.

Exemplary embodiments of the present invention will now be described with reference to the drawings. The same reference numerals and symbols are used for the same or corresponding components in the drawings.

In this specification, an imprinting process includes transfer of a mold pattern by depositing a resin to a substrate, impressing a mold on the deposited resin, and curing the resin using light or heat.

Step-and-repeat imprinting in which a process cycle including deposition, impression, and curing described above is repeated is performed in the following exemplary embodiments.

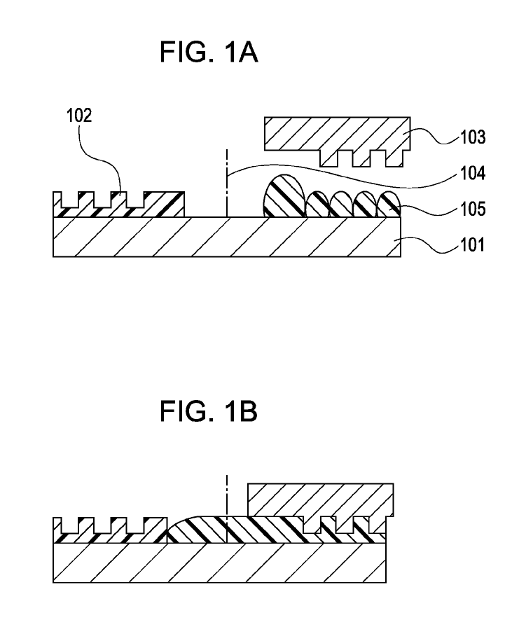

A first exemplary embodiment of a patterning method of the present invention will now be described. FIGS. 1A and 1B are cross-sectional views of a substrate. FIG. 1A illustrates a substrate 101, a patterned resin 102 to which a pattern of a mold 103 is transferred, the mold 103, a transfer boundary 104, and a pre-patterned resin 105 to which the pattern of the mold 103 is to be transferred.

FIG. 1A illustrates a state where the patterned resin 102 formed during a first imprinting process does not extend to the transfer boundary 104. In this case, the pre-patterned resin 105 is sufficiently spread during a subsequent second imprinting process, and a sufficient amount of the pre-patterned resin 105 is deposited to a portion in a transfer area adjacent to the patterned resin structure. More specifically, an amount of the pre-patterned resin 105 larger than that of the resin supplied during the first imprinting process per unit area is supplied to the portion of the substrate 101 adjacent to the patterned resin 102. In FIG. 1A, a larger amount of the pre-patterned resin is supplied to a portion substantially just below an end of the mold 103 and closest to the patterned resin 102. The resins can be deposited using, for example, an ink-jet apparatus or a pneumatic dispenser that can control the local distribution of the resins. The use of such an apparatus enables precise control of the ranges, densities, amounts, and shapes of the resins, resulting in patterns with uniform residual layer thicknesses.

FIG. 1B illustrates a state where the mold 103 is in contact with the pre-patterned resin 105. The pre-patterned resin 105 is pushed out of the mold 103 when the pre-patterned resin 105 spreads while wet over the substrate during this process since a sufficient amount of the pre-patterned resin 105 is deposited to the portion in the transfer area adjacent to the patterned resin 102. The area in which the resin spreads while wet is restricted in directions parallel to the surface of the substrate since the pre-patterned resin 105 pushed out of the mold is retained at an end surface of the patterned resin 102. As a result, the pattern of the mold can be transferred such that the base between two adjacent transferred patterns is not exposed.

Optionally, the amount of pre-patterned resin 105 deposited to the portion in the transfer area adjacent to the patterned resin 102 can be controlled in accordance with the extension of the patterned resin 102.

In the case where asperities or wettability of the surface of the substrate can be utilized or the extension of the pre-patterned resin 105 at the end of the mold 103 can be strictly controlled, the amounts and patterns of the resins deposited to the corresponding transfer areas can be equalized.

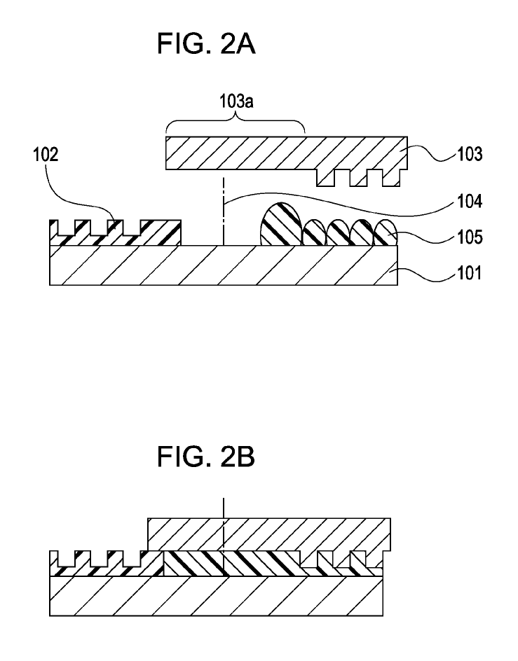

A second exemplary embodiment of a patterning method of the present invention will now be described with reference to cross-sectional views of a substrate in FIGS. 2A and 2B. In the second exemplary embodiment, patterns are formed with a uniform layer thickness by restricting extension of a pre-patterned resin not only in directions parallel to a surface of a substrate but also in a direction perpendicular to the surface (height direction).

A mold 103 whose unpatterned portion 103a is of such a size as to be brought into contact with or close to an adjacent patterned resin 102 during transferring is prepared. When the mold 103 is brought close to a pre-patterned resin 105, the unpatterned portion 103a of the mold 103 is brought into contact with or close to the upper surface of the patterned resin 102. In the first exemplary embodiment, extension of the pre-patterned resin 105 is restricted by the sidewall of the patterned resin 102 only in the directions parallel to the surface of the substrate. In the second exemplary embodiment, when the mold 103 having the unpatterned portion 103a is used, extension of the pre-patterned resin is also defined in the height direction by the mold 103 that is brought into contact with or close to the patterned resin 102 as shown in FIG. 2B. At this time, the pre-patterned resin is deposited with consideration of the amount of the resin flowing into the mold and a target thickness of a residual layer. Patterns with a substantially fixed layer thickness can be obtained by repeating these processes a plurality of times.

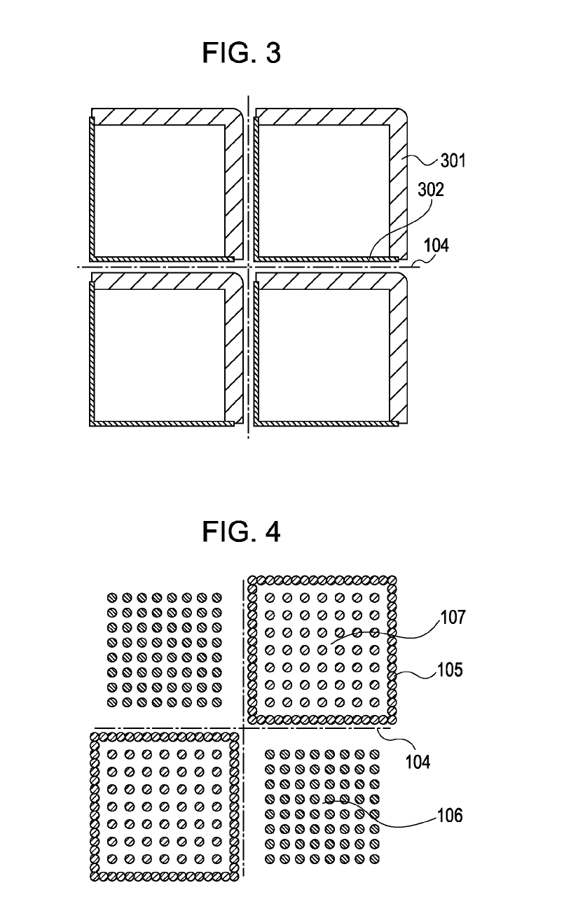

A third exemplary embodiment of a patterning method of the present invention in which exposure of a base at gaps between two adjacent transfer areas is reduced under one resin-depositing condition will now be described with reference to a top view in FIG. 3.

When patterns of a mold are successively transferred into transfer areas in a random order by the method according to the first exemplary embodiment, patterns of resins to be deposited to the transfer areas are changed in accordance with the distribution of the adjacent patterned resins. For example, when a square mold is used for repeated transfer in a random order into transfer areas arranged in a grid pattern, the maximum number of patterns of the resins to be deposited is sixteen. However, such a large number of deposition patterns may complicate the process, and may result in reduction in the reproducibility or precision of the patterned resin structures. To solve this, the nano-imprinting is performed under one resin-depositing condition in which parameters such as the size of areas to which pre-patterned resins are deposited, and the amount, pattern, and density of the resins to be deposited are fixed.

With reference to FIG. 3, rectangular imprint areas are arranged in an array sectioned by transfer boundaries 104. Two sides forming a corner in each rectangular imprint area are defined as a first boundary 301, and the other two sides are defined as a second boundary 302. Resin deposition for filling gaps between two adjacent imprint areas is adjusted in the vicinity of the first boundaries 301 of all the rectangular imprint areas. More specifically, the amount, density, range, pattern, and the like of the resins to be deposited are determined in accordance with the shapes of the adjacent patterns in the vicinity of (adjacent to) the first boundaries 301. Subsequent imprinting processes are performed such that the imprint areas to be formed do not face the adjacent imprint areas that have been already formed at the second boundary 302 thereof. In other words, imprinting is performed such that the first boundaries 301 of the imprint areas to be formed face the second boundaries 302 of the adjacent imprint areas that have already been formed. Patterns in which exposure of a base at gaps between two adjacent transfer areas is reduced can be obtained all over the imprint areas under one resin-depositing condition by repeating these processes. Array formation for realizing the above-described processes includes a case where patterns are always formed in a forward direction in rows and in a forward direction in columns.

A fourth exemplary embodiment of a patterning method of the present invention in which exposure of a base at gaps between two adjacent transfer areas is reduced under one or two resin-depositing conditions will now be described with reference to a top view in FIG. 4.

As shown in FIG. 4, first imprint areas 106 and second imprint areas 107 are both squares. First, an array of the first imprint areas 106 is formed such that the areas diagonally face each other (corners thereof face each other) and sides thereof do not face each other. For example, the array can be a checkered pattern. Next, the second imprint areas 107 are formed in the unoccupied spaces. For example, first, pre-patterned resins 105 are deposited in the first imprint areas 106 serving as one of the two checks such that the resins do not extend to transfer boundaries 104 after nano-imprinting. Subsequently, the pre-patterned resins 105 are deposited in the second imprint areas 107 serving as the other of the two checks such that the resins extend over the transfer boundaries 104 after nano-imprinting. With this, patterns in which the first imprint areas 106 and the second imprint areas 107 are connected with the resins and exposure of the base is reduced can be formed. With this method, only two resin-depositing patterns as shown in FIG. 4 are required, and issues such as reduction in reproducibility or precision of patterned resin structures described above can be solved.

Transfer can be performed in any order as long as the transfer boundaries 104 are covered with the resins, and can be performed in areas covering the transfer boundaries 104 first. Conditions of resin depositing and imprinting are determined so that patterning on the resins is not prevented, for example, so that a mold is not brought into contact with the patterned resins in the larger areas during subsequent patterning in the smaller areas.

The method for patterning in the checkered areas with different sizes has been described. However, in the case where asperities or wettability of the surface of the substrate can be utilized or the extension of the pre-patterned resins 105 at the end of the mold 103 can be strictly controlled, the amounts and patterns of the resins deposited to the corresponding transfer areas can be equalized. In this case, processes can be markedly simplified.

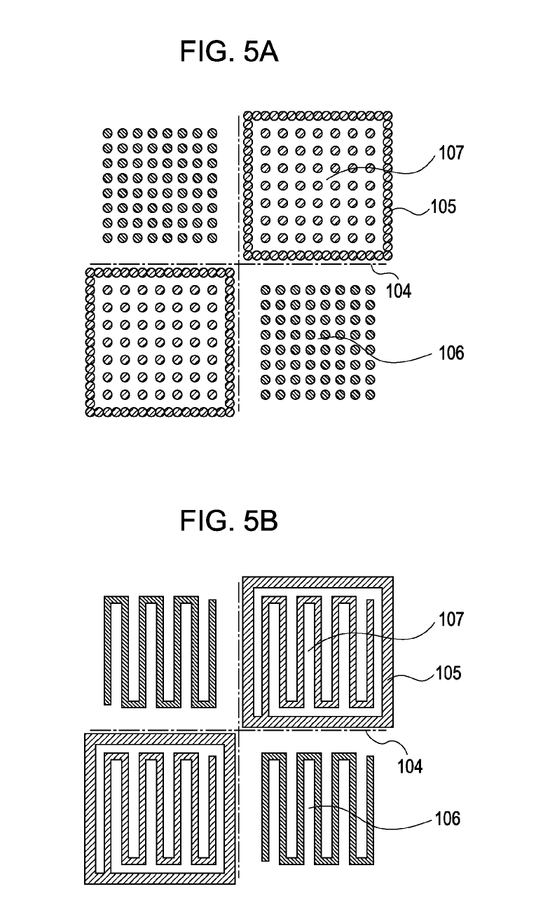

A fifth exemplary embodiment of arranging resin droplets that form resin-deposition patterns in transfer areas in accordance with the present invention will now be described with reference to top views in FIGS. 5A and 5B.

The range, density, and amount of pre-patterned resins 105 to be deposited are controlled using, for example, an ink-jet apparatus or a pneumatic dispenser that can control the local distribution of the resins. The resin droplets can be arranged in a continuous-line (linear) pattern as shown in FIG. 5B instead of a dot pattern as shown in FIG. 5A. The linear pattern can advantageously reduce the time for resin deposition.

However, when the resin droplets are arranged in a closed pattern constituted by continuous lines, parts that are not filled with the resins may appear since it is difficult to push air taken in the resins out the pattern. Therefore, the resin droplets can be arranged in a pattern constituted by discontinuous straight lines or curved lines instead of completely continuous lines so that air can easily escape.

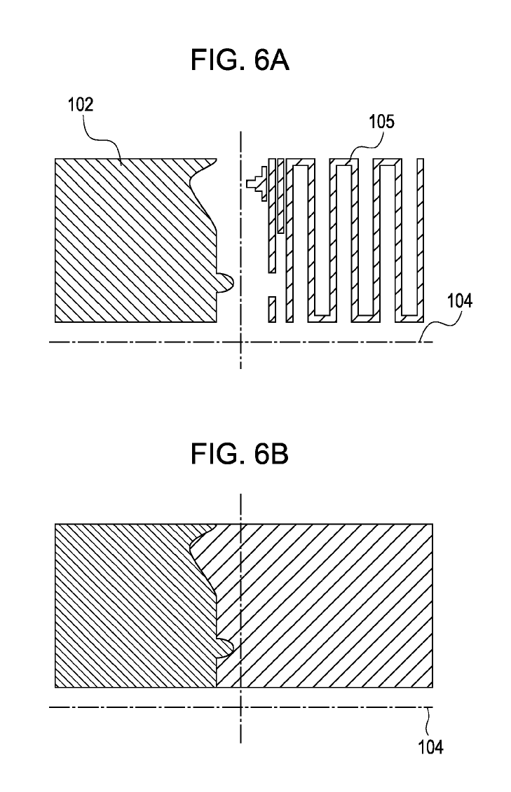

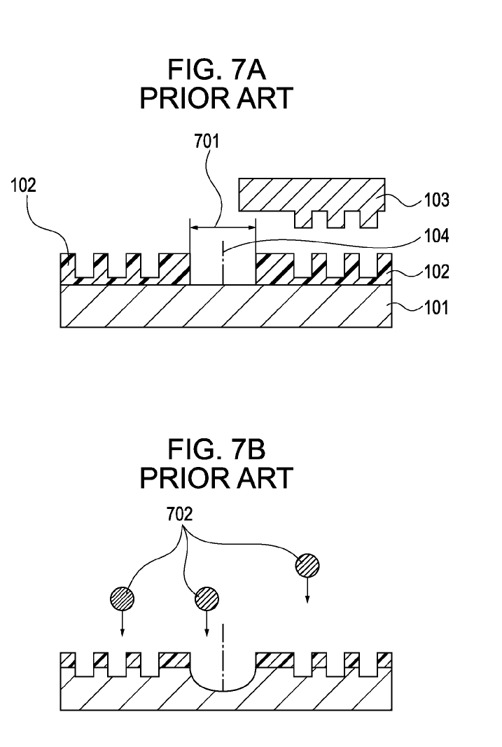

A sixth exemplary embodiment of a method of depositing a resin in accordance with the outer periphery of a patterned resin in accordance with the present invention will now be described with reference to top views in FIGS. 6A and 6B.

As shown in FIG. 6A, a pre-patterned resin 105 is deposited so as to fit the shape of a patterned resin 102. For example, when the borderline of the patterned resin 102 is recessed due to an insufficient flow of the resin, the pre-patterned resin 105 is deposited to a portion in a transfer area facing the recess while the resin-depositing conditions are changed such that the recess is filled with the resin. Subsequent nano-imprinting spreads the pre-patterned resin 105 to the patterned resin 102, resulting in patterns without exposure of a base at gaps between two adjacent patterns, as shown in FIG. 6B.

With this method, when foreign substances are taken in the pre-patterned resin 105 or precision of end surfaces of a mold is low, for example, patterns in which exposure of a base at gaps between two adjacent resin structures is reduced can be advantageously obtained while the projections and depressions of the resin are corrected. Moreover, since the resin is deposited so as to correspond to amounts required at each position, moving distance of the resin is reduced. This reduces the time for extension, and improves total throughput.

While the present invention has been described with reference to exemplary embodiments, it is to be understood that the invention is not limited to the disclosed exemplary embodiments. The scope of the following claims is to be accorded the broadest interpretation so as to encompass all modifications and equivalent structures and functions.

This application claims the benefit of Japanese Patent Application No. 2008-246335 filed Sep. 25, 2008, which is hereby incorporated by reference herein in its entirety.

What is claimed is:

1. An imprinting method for depositing resins to a substrate, bringing a mold into contact with the resins, and transferring a pattern formed on the mold to the resins, the method comprising:
a first imprinting process for transferring the pattern to a first resin; and
a second imprinting process for forming the pattern on a second resin in an area adjacent to an area formed during the first imprinting process, wherein
an amount of the second resin to be deposited during the second imprinting process is different from an amount of the first resin used during the first imprinting process so that a gap between the area formed during the first imprinting process and an area to be formed during the second imprinting process is filled.

2. The imprinting method according to claim 1, wherein the second resin is deposited to the area to be formed during the second imprinting process in accordance with the area formed during the first imprinting process, the second resin is spread by bringing the mold into contact with the second resin, and the area in which the second resin deposited during the second imprinting process spreads is restricted by the pattern formed during the first imprinting process so that the gap between the area formed during the first imprinting process and the area formed during the second imprinting process is filled.

3. The imprinting method according to claim 1, wherein the amount of the second resin per unit area supplied to the substrate adjacent to the area formed during the first imprinting process is larger than the amount of the first resin supplied to the area formed during the first imprinting process, and the second resin is spread by contact with the mold.

4. The imprinting method according to claim 1, wherein the amounts of the resins are adjusted by adjusting at least one of the densities, patterns, and ranges of the resins to be deposited.

5. The imprinting method according to claim 1, wherein the amounts of the resins are controlled such that the gap between two adjacent areas is filled.

6. The imprinting method according to claim 1, wherein a height of the second resin is defined by using a mold having a patterned portion and an unpatterned portion formed outside the patterned portion, the unpatterned portion being brought into contact with or close to an upper surface of a patterned resin structure in the area formed during the first imprinting process.

7. The imprinting method according to claim 1, wherein when an array of square imprint areas is formed during imprinting processes including the first imprinting process and the second imprinting process, and when sides, of the area formed during the second imprinting process, that are the closest to the areas formed during the first imprinting process are defined as a first boundary and the other sides are defined as a second boundary, the amount of the second resin deposited adjacent to the first boundary is adjusted so that the gaps between the areas formed during the first imprinting process and the area to be formed during the second imprinting process are filled.

8. The imprinting method according to claim 1, wherein when an array of square imprint areas is formed during imprinting processes including the first imprinting process and the second imprinting process, the areas formed during the first imprinting process face each other at the corners of the areas and do not face each other at the sides of the areas, and the second imprinting process is performed in the areas surrounded by the areas formed during the first imprinting process.

9. The imprinting method according to claim 1, wherein a resin-depositing condition for the area to be formed during the second imprinting process is changed in accordance with projections and depressions of a border of the area formed during the first imprinting process.

10. The imprinting method according to claim 7, wherein identical resin-depositing conditions are used for the areas formed during the first imprinting process in all the square imprint areas.

11. The imprinting method according to claim 1, wherein the resins deposited to the substrate form continuous or discontinuous lines.

12. An imprinting method for depositing resin to a substrate, bringing a mold into contact with the resin, and transferring a pattern formed on the mold to the resin, the method comprising:
adjusting an amount of the resin to be deposited such that a gap is not formed between a patterned portion of the resin and a pre-patterned portion of the resin to be patterned during transfer of the pattern.

13. The imprinting method according to claim 12, wherein when the pre-patterned portion of the resin is deposited to the substrate, the amount of the pre-patterned resin deposited adjacent to the patterned resin is larger than the amount of the pre-patterned resin deposited to a central portion of the pattern.

14. An imprinting method for depositing resins to a substrate, bringing a mold into contact with the resins, and transferring a pattern formed on the mold to the resins, the method comprising:
bringing the mold into contact with pre-patterned resin such that the pre-patterned resin spreads over a surface of the substrate and comes into contact with patterned resin during transfer of the pattern to the pre-patterned resin.

15. The imprinting method according to claim 15, wherein the amount of the pre-patterned resin is larger than the amount of the patterned resin with which the pre-patterned resin comes into contact during transfer of the pattern to the pre-patterned resin.

16. The imprinting method according to claim 15, wherein the amount of the patterned resin corresponds to an amount used for forming a pattern on the substrate.
